(19) United States
(12) Patent Application Publication
(10) Pub. No.: US 2010/0326222 A1
(43) Pub. Date: Dec. 30, 2010

(54) Vibration exciter

(75) Inventors: Christian Heichel, Niedernberg (DE); Albrecht Kleibl, Grosshennersdorf (DE)

Correspondence Address: COLLARD & ROE, P.C., 1077 NORTHERN BOULEVARD, ROSLYN, NY, 11576, US

(73) Assignee: ABI Anlagentechnik-Baumaschinen-Industriebedarf Maschinenfabrik und Vertriebsgesellschaft mbH, Niedernberg (DE)

(21) Appl. No.: 12/802,329

(22) Filed: Jun. 4, 2010

(30) Foreign Application Priority Data
Jun. 26, 2009 (EP) 09008359.3

(51) Int. Cl. B06B 1/16

(52) U.S. Cl. 74/61

(57) ABSTRACT

A vibration exciter, particularly for a vibration pile driver, has an exciter transmission having at least two imbalance masses, which are attached on one or on multiple shafts, and a pivot motor for adjusting the relative rotational position of the imbalance masses relative to one another. A pump for supplying the pivot motor is provided, which pump is operated by way of a shaft of the exciter transmission.

### CROSS REFERENCE TO RELATED APPLICATIONS

Applicants claim priority under 35 U.S.C. 119 of European Application No. 09008359.3 filed Jun. 26, 2009.

### BACKGROUND OF THE INVENTION

1. Field of the Invention

The invention relates to a vibration exciter, particularly for a vibration pile driver.

2. The Prior Art

In construction, vibration generators such as vibrators, shakers, or vibration bears, are used to introduce profiles into the ground, or to draw them from the ground, or also to compact ground material. The ground is excited by vibration, and thereby achieves a “pseudo-fluid” state. The goods to be driven in can then be pressed into the construction ground by a static top load. The vibration is characterized by a linear movement and is generated by rotating imbalances that run in opposite directions, in pairs, within an exciter operation. Alternatively, vibration generators that have a circumferential effect are possible, in which the vibration is characterized by a helical oscillation. Vibration generators are characterized by the installed imbalance (static moment) and the maximal speed of rotation.

In order to achieve an optimal forward drive, i.e. good compaction, as a function of the goods being driven and the ground properties, it is necessary to adjust the vibration by changing the static moment of the phasing of the imbalances. When the vibration exciter is started up, it passes through the inherent frequency range of the ground. If the ground is excited in the resonance range, the amplitude of the ground vibration becomes very great, and this can lead to damage of adjacent buildings. For this reason, it is necessary that when the vibration exciter is started up, no imbalances are in effect.

German Patent No. DE 20 2007 005 283 U1 describes a vibration exciter comprising an exciter transmission having shafts disposed parallel to one another. Gear wheels with imbalance masses are disposed on the shafts. A pivot motor is provided, by way of which the position of the imbalance masses relative to one another are adjustable, to change the static moment. The media supply to the working chambers of the pivot motor takes place by way of the drive hydraulics.

The previously known vibration exciter has proven itself in practice. The use of a rotor pivot motor allows a relative adjustment of the imbalance masses relative to one another, with a conversion of a linear movement into a rotational movement being required, to achieve a compact construction. However, the hydraulic connection of the pivot motor within the exciter transmission has proven to be problematical. The pivot motor is connected with the hydraulics of the carrier device by way of a rotary joint. In this connection, however, the hydraulic pressure can be different, depending on the work operation. The pressure being applied can sometimes drop below the minimum pressure that is required for proper operation of the pivot motor. This has the result that the end position of the pivot motor is either not achieved at all, or is achieved too slowly. Furthermore, the rotary joint of the pivot motor is subject to wear, and therefore leaks can occur, by way of which hydraulic oil can get into the transmission oil. As a result, the lubricant properties of the transmission oil are impaired. Furthermore, the oil level in the transmission can increase. Such an increase in the oil level in turn brings about a hindrance of the movement of the rotating parts, and this can result in a temperature increase of the vibration exciter, connected with a power decrease.

### SUMMARY OF THE INVENTION

It is therefore an object of the invention to provide a pivot motor of the type stated initially, in which the aforementioned problems are avoided. According to the invention, this object is accomplished by a vibration generator, in which reliable adjustment of the static moment is guaranteed, and impairment of the transmission oil is avoided. By operating the pivot motor via a pump that is driven by a shaft of the exciter transmission, the pivot motor is uncoupled from the work operation of the carrier device. In addition, when the pivot motor is operated with transmission oil of the exciter transmission, contamination of the transmission oil by leaks of the pivot motor is prevented.

In a further development of the invention, the pump for supplying the pivot motor is also the lubricant oil pump of the exciter transmission. In this way, a reduction in the number of components as well as a compact structure of the vibration exciter is achieved. The pivot motor is supplied at a constant oil pressure, and the applied pressure is clearly higher here than when the pivot motor is operated by way of the hydraulic system of the carrier device according to the state of the art. As a result, the pivot motor can be dimensioned to be smaller.

In one embodiment of the invention, the lubricant oil pump of the exciter transmission is operated by way of a shaft of the exciter transmission. As a result, the larger dimensioning of the pump that is required for the additional supply of the pivot motor can be achieved with a compact construction.

In another embodiment of the invention, the pivot motor has a rotary joint for the fluid supply.

In a further development of the invention, a filter is disposed in the supply line of the pivot motor. As a result, impairment of the pivot motor by dirt particles present in the transmission oil is counteracted.

In another embodiment of the invention, the pivot motor comprises a rotor shaft and a stator housing, in addition to means for locking the stator housing in place with the rotor shaft. As a result, a constant position of the imbalances, with simultaneous stress relief of the supply system of the pivot motor, is achieved during operation of the vibration exciter. The pump for supplying the pivot motor only has to work against the adjustment pressure when the pivot motor is actually being turned on.

Preferably, the means for locking in place is formed by a spring-pressure multi-disk brake. As a result, a compact construction is possible. It is advantageous if the means for locking in place can be activated hydraulically.

In another embodiment of the invention, the inflow line of the pivot motor has an inflow valve assigned to it, which is set up in such a manner that the inflow line only has pressure applied to it when the pivot motor is turned on. As a result, stress relief of the supply pump of the pivot motor is brought about.

It is advantageous if a control device is provided, which is set up so that when the pivot motor is turned on, deactivation of the means for locking in place occurs at the same time. As a result, the pivot motor is coordinated with the means for locking in place.

Preferably, the control device is additionally set up to control the inflow valve, so that the inflow valve is switched for through-flow when the pivot motor is not being turned on.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows a schematic representation of a vibration generator with a separate supply pump of the pivot motor;

FIG. 2 shows the schematic representation of a vibration generator with only one supply pump for exciter transmission and pivot motor;

FIG. 3 shows the schematic representation of a hydraulic circuit schematic for operation of the pivot motor with transmission oil;

FIG. 4 shows a longitudinal sectional view of a vibrator transmission; and

FIG. 5 shows a longitudinal sectional view of a rotor pivot motor having a spring-pressure multi-disk brake.

### DETAILED DESCRIPTION OF THE PREFERRED EMBODIMENT

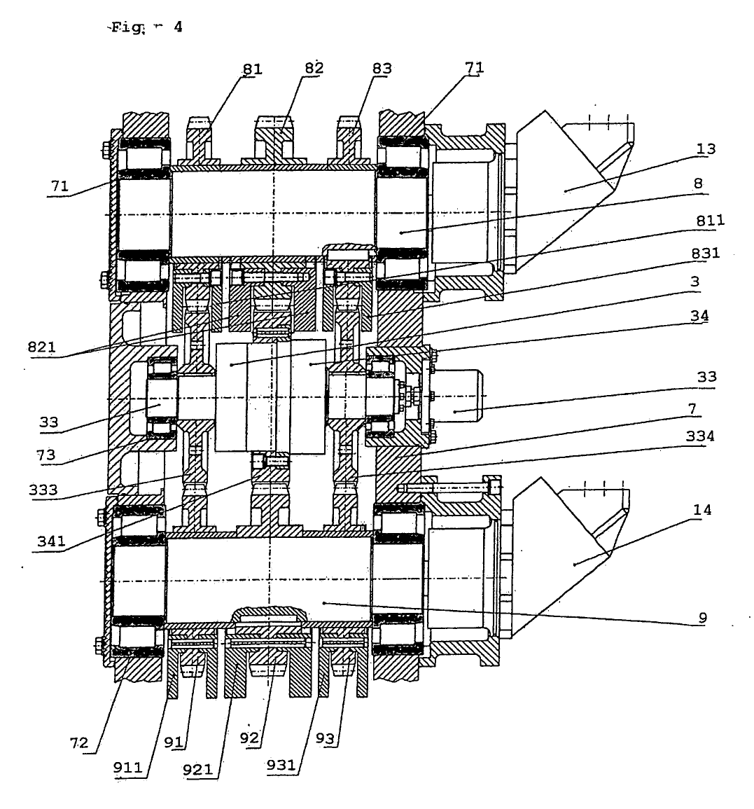

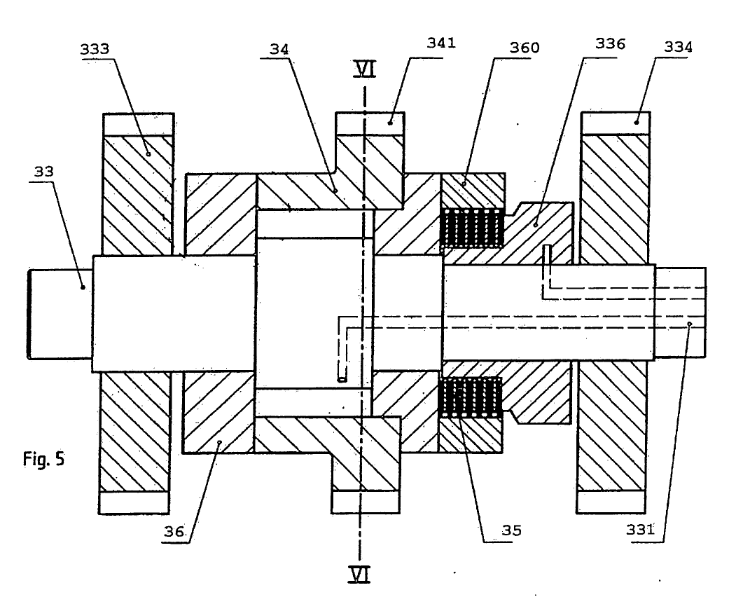

Referring now in detail to the drawings, in particular FIG. 4, the vibration generator selected as an exemplary embodiment is configured as an exciter transmission, essentially consisting of a housing 7 in which two shafts 8, 9 provided with gear wheels 81, 82, 83, and 91, 92, 93, respectively, are mounted so as to rotate, as well as a pivot motor 3 whose rotor shaft 33 is provided with gear wheels 333, 334 and whose stator housing 34 is provided with a gear wheel 341. With regard to the embodiment of the exciter transmission, reference is made to the explanations of DE 20 2007 005 283 U1 the disclosure of which is herein incorporated by reference.

Shaft 8 is mounted to rotate in bearings 71 of housing 7. An outer gear wheel 81 is disposed on shaft 8, mounted so as to rotate; the opposite outer gear wheel 83 is connected with shaft 8 so as to rotate with it. Gear wheels 81, 83 are each provided with imbalance masses 811, 831. Furthermore, a gear wheel 82 is disposed on shaft 8, mounted so as to rotate, centered between gear wheels 81, 83. Gear wheel 82 is also provided with an imbalance mass 821. In the exemplary embodiment, shaft 8 is connected with a drive 13. Furthermore, a shaft 9 is rotatably mounted by means of bearings 72, lying opposite shaft 8 in housing 7. Shaft 9 is provided with three gear wheels 91, 92, 93, in the same manner as shaft 8, and imbalance masses 911, 921, 931 are attached to them. In contrast to shaft 8, however, outer gear wheels 91, 93 are connected with shaft 9 so as to rotate; and gear wheel 92 disposed between gear wheels 91, 93 is attached to shaft 9 so as to rotate with it. In the exemplary embodiment, shaft 9 is connected with a drive 14.

Between shafts 8, 9, a shaft 33 is mounted in housing 7, so as to rotate, by way of bearings 73. Shaft 33 is essentially the rotor shaft of a pivot motor 3 disposed centered on it. On both sides of pivot motor 3, gear wheels 333, 334 are disposed on shaft 33, so as to rotate with it. Gear wheels 333, 334 are positioned on the shaft 33 in such a manner that they engage gear wheels 81, 91 and 83, 93, respectively, of shafts 8, 9. Furthermore, a gear wheel 341 is disposed on stator housing 34 of pivot motor 3, so as to rotate with it. Gear wheel 341 is positioned on stator housing 34 in such a manner that it engages gear wheels 82, 92 of shafts 8, 9.

Channels 331 for supplying media to the working chambers and to the multi-disk brake 35 by means of the hydraulic system are worked into the shaft 33.

In the embodiment according to FIG. 5, the pivot motor is provided with a multi-disk brake 35. Multi-disk brake 35 consists of a housing 360 attached to lid 36 of stator housing 34, a hub 336 attached to shaft 33, and a clutch disk package 37. When the clutch disks that mesh with housing 360 are pressed against the clutch disks that mesh with the hub connected with rotor shaft 33, locking of stator housing 34 with rotor shaft 33 is brought about.

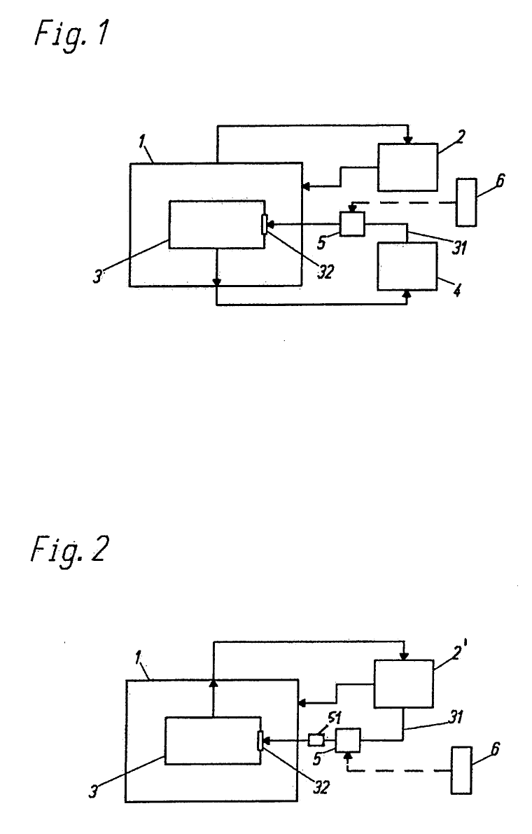

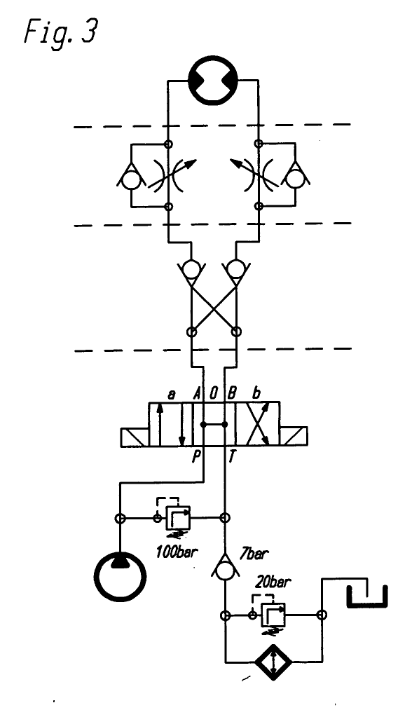

As shown in FIG. 1, exciter transmission 1 is connected with a lubrication pump 2, in order to lubricate the rotating parts with transmission oil. Lubrication pump 2 conveys the transmission oil contained in a reservoir tank of the housing of exciter transmission 1 to the corresponding lubricating locations, under high pressure.

Pivot motor 3 disposed in exciter transmission 1 is connected with another supply pump 4 by way of inflow lines 31. Supply pump 4 conveys transmission oil from the reservoir tank of exciter transmission 1 into the working chambers of pivot motor 3. A filter 51 as well as an inflow valve 5 are disposed in feed lines 31, by way of which valve the supply to the working chambers of pivot motor 3 can be controlled. In the exemplary embodiment, inflow valve 5 is a 4/3-way valve. The inflow valve can be controlled by way of a control module 6 with which inflow valve 5 is connected. For this purpose, inflow valve 5 configured as a 4/3-way valve is configured so that it can be controlled electromagnetically.

Inflow lines 31 are connected with pivot motor 3 by way of a rotary joint 32. In this connection, rotary joint 32 is disposed on pivot motor 3 without any additional seals. The leakage caused by this is not of any significance for the operation of the vibration generator, since the exiting transmission oil gets back into the reservoir of the housing of the exciter transmission 1. Because of the higher viscosity of the transmission oil, the leakage of the rotary joint is slight, as is the internal leakage of pivot motor 3. Since the leakage of rotary joint 32 and of pivot motor 3 as well as the oil displaced out of pivot motor 3 no longer flow into the leakage oil line, this line is relieved of stress, and therefore the leakage oil pressure drops.

In the embodiment according to FIG. 2, only one pump 2′ is provided, which takes on both the tasks of lubrication pump 2 and the tasks of supply pump 4 of pivot motor 3 in the embodiment according to FIG. 1. For this purpose, pump 2′ is dimensioned to be bigger. To reduce the overall installation size, pump 2′ in the embodiment according to FIG. 2 is operated by way of a shaft of exciter transmission 1.

Accordingly, while only a few embodiments of the present invention have been shown and described, it is obvious that many changes and modifications may be made thereunto without departing from the spirit and scope of the invention.

What is claimed is:

1. A vibration generator comprising:
an exciter transmission having at least two imbalance masses, which are attached on one or on multiple shafts;
a pivot motor for adjusting a rotational position of the imbalance masses relative to one another; and
a pump for supplying the pivot motor, said pump being operated by way of a shaft of the exciter transmission.

2. The vibration generator according to claim 1, wherein the pivot motor is operated with transmission oil of the exciter transmission.

3. The vibration generator according to claim 2, wherein the pump for supplying the pivot motor also acts as a lubrication pump of the exciter transmission.

4. The vibration generator according to claim 1, wherein the pivot motor has a rotary joint for supplying fluid.

5. The vibration generator according to claim 1, wherein the pivot motor has an inflow line and a filter is disposed in the inflow line.

6. The vibration generator according to claim 1, wherein the pivot motor comprises a rotor shaft and a stator housing, and further comprising means for locking the stator housing in place with the rotor shaft.

7. The vibration generator according to claim 6, wherein the means for locking in place is formed by a spring-pressure multi-disk brake.

8. The vibration generator according to claim 6, wherein the means for locking in place is hydraulically activated.

9. The vibration generator according to claim 5, further comprising an inflow valve disposed in the inflow line of the pivot motor, said valve being arranged such that the inflow line only has pressure applied to it when the pivot motor is being turned on.

10. The vibration generator according to claim 6, further comprising a control device that deactivates the means for locking in place at the same time that the pivot motor is turned on.

11. The vibration generator according to claim 10, wherein the control device controls an inflow valve in an inflow line of the pivot motor in such a manner that the inflow valve is switched to through-flow when the pivot motor is not turned on.

12. The vibration generator according to claim 8, wherein the inflow valve is electromagnetically controlled.
